(19) United States
(12) Patent Application Publication
(10) Pub. No.: US 2003/0026013 A1
(43) Pub. Date: Feb. 6, 2003

(54) Optical filter and method for producing the same

(76) Inventor: Takashi Tsutsumi, Osaka (JP)

Correspondence Address: BIRCH STEWART KOLASCH & BIRCH, PO BOX 747, FALLS CHURCH, VA, 22040-0747, US

(21) Appl. No.: 10/178,733

(22) Filed: Jun. 25, 2002

(30) Foreign Application Priority Data
Jul. 3, 2001 (JP) 2001-201983

(51) Int. Cl. G02B 5/20

(52) U.S. Cl. 359/885

(57) ABSTRACT

The invention provides an optical filter not having any discontinuous portion from the maximum transmissivity to the minimum transmissivity, which is excellent in linearity. The optical filter includes a first member 1 provided with an inclined plane erected from the flat plane 3b of a rectangular base at an acute angle θ, and a second member 2 provided with an inclined plane erected from the flat plane 3a of a rectangular base at an acute angle and having an optical feature which is different from that of the above-described first member, wherein the inclined planes of the above-described two members are thermally adhered to each other.

### FIELD OF THE INVENTION

The present invention relates to an optical filter having no discontinuous portion from the maximum transmissivity and the minimum transmissivity, and a method for producing the same.

### DESCRIPTION OF THE RELATED ART

Where the intensity of transmitting light is continuously changed, for example, a wedge filter whose transmissivity continuously changes is used, wherein the relative position of spot light and the wedge filter are varied by an adequate scanning mechanism. In such a wedge filter, linearity of a change in the transmissivity is important. In particular, it is remarkably important that there is no discontinuous portion from the minimum transmissivity to the maximum transmissivity.

However, conventionally, no filter to meet such needs has been provided.

The present invention was developed in view of the above-described problems, and it is therefore an object of the invention to provide a filter having no discontinuous portion from the maximum transmissivity to the minimum transmissivity, which is excellent in linearity.

### SUMMARY OF THE INVENTION

In order to solve the above problems, a method for producing an optical filter according to the invention is featured in that a plurality of glass members each having a different transmissivity are disposed adjacent to each other, the above-described glass members are brought into contact with each other by thermal expansion in line with heating, and the above-described glass members are integrated together by pressurization.

With the invention, it is preferable that glass members having almost the same thermal expansion coefficients are used. It is further preferable that glass members whose refractive indexes are also almost the same are used. These points are also applicable to the invention according to claim 4, which is described below.

Also, an optical filter is comprised of a first member provided with an inclined plane erected from the flat plane of a rectangular base at an appointed acute angle and a second member provided with an inclined plane erected from the flat plane of a rectangular base at an appointed acute angle and having an optical feature which is different from that of the above-described first member, wherein the inclined planes of the above-described two members are thermally adhered to each other.

### BRIEF DESCRIPTION OF THE DRAWINGS

FIG. 1 is a view describing a method for producing an optical filter according to the invention.

### PREFERRED EMBODIMENTS OF THE INVENTION

Hereinafter, a further detailed description is given of the invention on the basis of embodiments.

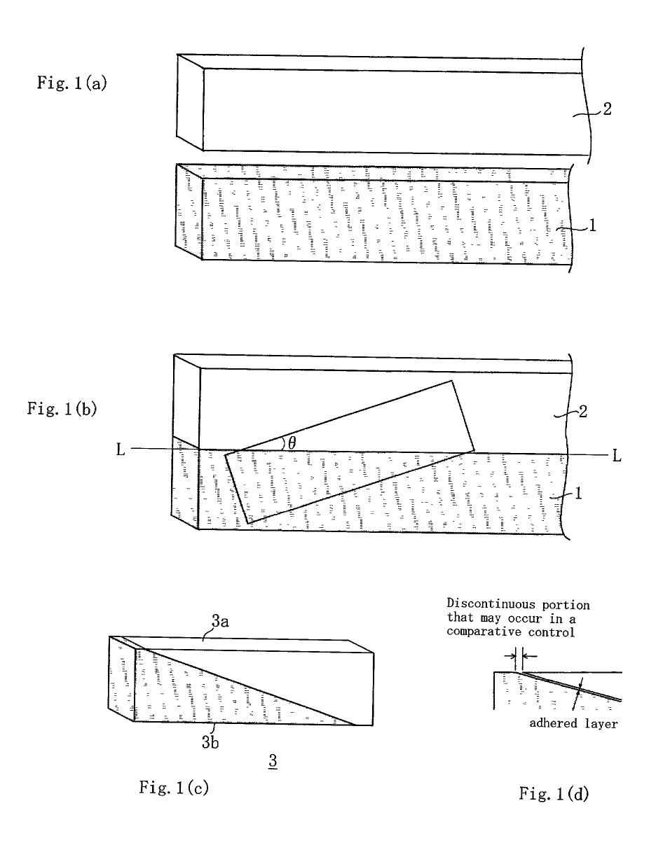

FIG. 1 is a view describing a method for producing a wedge filter according to an embodiment. In order to produce a wedge filter, first, as shown in FIG. 1(a), the first glass member 1 is placed on a surface plate whose top surface is horizontal. Also, the second glass member 2, both ends of which are horizontally held, is made to approach the first glass member 1 and is disposed thereon. In addition, the upper surface la of the first glass member 1 and the underside 2a of the second glass member 2 are optically polished in a super accurate state.

After that, both glass members 1 and 2 are heated, wherein the middle portion of the second glass member is caused to suspend in line with thermal expansion, and the second glass member 2 and the first glass member 1 are brought into contact with each other. And, as the thermal expansion further advances, the contacting portion of both glass members 1 and 2 spreads from the middle portion to the peripheries thereof. Thus, since, in the production method, the contacting portion spreads from the middle portion to the peripheries, no air bubbles are permitted to exist, wherein complete contacting can be brought about.

As both glass members 1 and 2 are brought into contact with each other, pressurization is given to the members from above the second glass member 2, wherein the boundary phase between the first glass member 1 and the second glass member 2 is integrated, and thermal cementing thereof is completed.

After the integrated glass members 1 and 2 are cooled down, a rectangular pallalelepiped is cut out, inclining it by a cutout angle θ from the contacting line L-L as shown in FIG. 1(b). Then, a wedge filter member 3 is completed as shown in FIG. 1(c). Also, the larger the cutout angle θ becomes, the steeper the inclination in changes in the transmissivity becomes.

After that, input and output end faces 3a and 3b through which light passes are optically polished, and the other end faces are adequately sand-polished. And, AR coating (reflection-preventing coating) is carried out on the optically polished input and output end faces 3a and 3b.

Since the method for producing an optical filter according to the present embodiment is carried out by the above-described processes, it is possible to complete a highly accurate wedge filter having no discontinuous portion in transmissivity. That is, for example, as shown in FIG. 1(d), since an adhering layer is unavoidable between the first glass member 1 and the second glass member 2 where an adhesive agent is used, a gap in transmissivity is formed at the point. However, according to the method brought about by the invention, complete continuance in transmissivity can be achieved.

Further, since no adhesive agent is used, the wedge filter is excellent in chemical resistance, water resistance, and weather resistance. Still further, a high-quality coating surface can be formed by employing a thermal cementing method. That is, for example, in a case where an adhesive agent is used, since the adhesive agent is not durable against heat, only a low-temperature coated surface can be brought about, wherein the quality of the AR coating surface is made inferior.

Also, it is needless to say that any transmissivity inclination can be created by varying the cutout angle 0.

Table 1 and Table 2 show compositions of the first glass member and the second glass member according to the embodiment. The optical filter can be utilized as a wedge filter that constitutes an attenuator in optical transmissions (use frequency wavelength is 1300 nm through 1600 nm). Also, Table 3 shows the characteristics thereof, and the two glass members have almost the same thermal expansion coefficients. In addition, the refractive indexes thereof are almost the same. As the light wavelength changes, the composition of the first glass member may change.

TABLE 1
Sample 1

| Material | Weight | SiO₂ | Al₂O₃ | B₂O₃ | Na₂O | CaO | Co₂O₃ | Sb₂O₃ |
|---|---|---|---|---|---|---|---|---|
| F—SiO₂ | 30.95 | 30.857 | | | | | | |
| Al₂O₃ | 0.6 | | 0.6 | | | | | |
| Na₂B₄O₇ | 1.6 | | | 1.107 | 0.492 | | | |
| Na₂CO₃ | 13.1 | | | | 7.664 | | | |
| NaNO₃ | 3.75 | | | | 1.369 | | | |
| CaCO₃ | 11.2 | | | | | 6.206 | | |
| Co₂O₃ | 0.65 | | | | | | 0.65 | |
| Sb₂O₃ | 0.15 | | | | | | | 0.15 |
| | 49.095 | 30.857 | 0.6 | 1.107 | 9.525 | 6.206 | 0.65 | 0.15 |
| Weight | 100 | 62.852 | 1.222 | 2.255 | 19.401 | 12.641 | 1.324 | 0.306 |
| percent | | | | | | | | |

TABLE 2
Sample 2

| Material | Weight | SiO₂ | Al₂O₃ | B₂O₃ | Na₂O | CaO | Sb₂O₃ |
|---|---|---|---|---|---|---|---|
| F—SiO₂ | 32.25 | 32.153 | | | | | |
| Al₂O₃ | 0.6 | | 0.6 | | | | |
| Na₂B₄O₇ | 1.6 | | | 1.107 | 0.492 | | |
| Na₂CO₃ | 13.1 | | | | 7.664 | | |
| NaNO₃ | 3.75 | | | | 1.369 | | |
| CaCO₃ | 11.2 | | | | | 6.206 | |
| Sb₂O₃ | 0.15 | | | | | | 0.15 |
| | 49.741 | 32.153 | 0.6 | 1.107 | 9.525 | 6.206 | 0.15 |
| Weight | 100 | 64.641 | 1.206 | 2.226 | 19.149 | 12.477 | 0.302 |
| percent | | | | | | | |

TABLE 3

| Test | α | Transfer | Yield | Annealing | Strain |
|---|---|---|---|---|---|
| sample | (30 through 300° C.) | point | point | point | point |
| Co-AB | 108 × 10⁻⁷/° C. | 538° C. | 595° C. | 545° C. | 501° C. |
| Co—A | 110 × 10⁻⁷/° C. | 528° C. | 579° C. | 534° C. | 488° C. |

α: Linear expansion coefficient

[Effects of the Invention]

As described above, according to the invention, it is possible to realize an optical filter not having any

What is claimed is:

1. A method for producing an optical filter in which a plurality of glass members each having a different transmissivity are disposed adjacent to each other, said glass members are brought into contact with each other by thermal expansion in line with heating, and said glass members are integrated together by pressurization.

2. The method for producing an optical filter according to claim 1, wherein the direction of said pressurization is orthogonal to the contacting plane.

3. The method for producing an optical filter according to claim 1 or 2, wherein, after said glass members are integrated together, said integrated glass members are cut out in the form of a rectangular parallelepiped at an appointed cut-off angle from the contacting plane.

4. An optical filter comprising a first member provided with an inclined plane erected from the flat plane of a rectangular base at an appointed acute angle, and a second member provided with an inclined plane erected from the flat plane of a rectangular base at an appointed acute angle and having an optical feature which is different from that of said first member, wherein the inclined planes of said two members are thermally adhered to each other.

5. The optical filter according to claim 4, wherein the erecting angles of the inclined planes of said two members are the same, and said optical feature is optical transmissivity.

6. The optical filter according to claim 4 or 5, wherein a reflection preventing membrane is formed on the base flat planes of said first members and said second member.

7. The optical filter according to any one of claims 4 through 6, wherein the first member and the second member are disposed adjacent to each other, are caused to be brought into contact with each other by thermal expansion in line with heating, and are integrated together by pressurization.

8. The optical filter according to claim 7, wherein the direction of said pressurization is orthogonal to the contacting plane.

9. The optical filter according to claim 8, wherein after both of said members are integrated together, the members are cut out in the form of a rectangular parallelepiped at said appointed acute angle from the contacting plane.
